(19) United States
(12) Patent Application Publication
(10) Pub. No.: US 2011/0141299 A1
(43) Pub. Date: Jun. 16, 2011

(54) Low cost combination spectral-spatial vision system

(75) Inventor: Billy R. Masten, Shallowater, TX (US)

(73) Assignee: Masten Opto-Diagnostics Company

(21) Appl. No.: 12/082,493

(22) Filed: Apr. 11, 2008

Related U.S. Application Data
(63) Continuation-in-part of application No. 11/494,080, filed on Jul. 27, 2006, now Pat. No. 7,417,731.
Application No. 11/494,080 is a continuation of application No. 11/029,553, filed on Jan. 5, 2005, now Pat. No. 7,099,004.
Application No. 11/029,553 is a continuation of application No. 09/849,831, filed on May 4, 2001, now Pat. No. 6,919,959.
Application No. 09/849,831 is a continuation-in-part of application No. 09/343,855, filed on Jun. 30, 1999, now abandoned.
Application No. 09/343,855 is a continuation-in-part of application No. 10/655,711, filed on Sep. 4, 2003, now Pat. No. 7,362,423.
(60) Provisional application No. 60/408,711, filed on Sep. 6, 2002.

(51) Int. Cl. H04N 5/228; G06K 9/00

(52) U.S. Cl. 348/222.1; 382/100; 348/E05.031

(57) ABSTRACT

A combined spectral and spatial sensing unit having a lens for receiving light from an object or substance and for directing at least a portion thereof through a diffraction device to an area imager for creating a digital spectral image of a plurality of segments of different wave lengths of light on a first set of pixels of said imager and for creating a digital spatial image on a second set of pixels of said imager, and an analytical unit having a microprocessor for receiving each of said images and comparing same to images stored in a memory associated with said microprocessor to determine the identity, condition or other information about the object or substance. Alternatively, a portion of said light may be directed through a diffraction grating to a first imager and another portion to a second imager, each of which is associated with a microprocessor for determining the identity, condition or other information about the object or substance.

### CROSS REFERENCE TO RELATED APPLICATIONS

This application is a Continuation-In-Part Application of application Ser. No. 11/494,080 filed Jul. 27, 2006 which entitled Scanning Sensor-Identifier and Standard Set-Up, now U.S. Pat. No. ______ which is a Continuation of application Ser. No. 11/029,553 filed Jan. 5, 2006, (now U.S. Pat. No. 7,099,004) which is a continuation of No. 09/849,831 filed May 4, 2001 entitled Digital Spectral Identifier-Controller and Related Methods (now U.S. Pat. No. 6,919,959) which is a Continuation-in-Part of application Ser. No. 09/343,855 filed Jun. 30, 1999 entitled Digital Spectral Identifier-Controller and Related Methods. This application is also a Continuation-In-Part Application of application Ser. No. 10/655,711 filed Sep. 4, 2003 entitled Digital Diagnostic Apparatus and Vision System with Related Methods, now U.S. Pat. No. 7,362,423 which claims the benefit of U.S. Provisional Application, Ser. No. 60/408,711 filed Sep. 6, 2002. Each of the above identified patent applications and patents are also incorporated by reference into this application.

### FIELD OF INVENTION

This invention is primarily directed to electronic vision apparatus and methods 1) for identifying objects, substances and species of objects, including plants, materials, chemicals, fluids and gasses, etc., 2) for making color (spectral) and/or dimensional (spatial) analysis, and 3) for determining the status, condition of such objects and substances. The invention will have application in the fields of plant identification, machine vision, medicine, environmental pollution, security, bill counters, changers, quality control of extrusions, webs and in other fields. The invention may be used for spectral identifications and analysis, spatial analysis as well as a combination of spatial and spectral identification and analysis.

### THE PRIOR ART

Vision systems using imagers and frame grabbers associated with computers are well known and used for determining the quality, dimensions, etc. of manufactured parts. In addition, there have been efforts to design vision systems of lower costs that serve as sensors, analyzers, identifiers, etc. that use lower cost, specific designs mounted on circuit boards to sense, analyze or identify different objects, materials, fluids, etc. Illustrative of these efforts are the following patents:

U.S. Pat. No. 4,560,274 (Goetz) discloses a portable spectrometer for mineral identification which uses imaging optics to direct reflected light onto an imaging array whose output is transferred through an analog to digital converter to a microprocessor. This microprocessor projects the output to a display screen so that the output of the imager can be visually compared with pre-recorded outputs from known minerals. Goetz also suggests that an unidentified algorithm might be used to identify the mineral in question.

U.S. Pat. No. 6,763,132 (Shimada) teaches the use of a lens to direct reflected light to an imager whose output is transferred through an analog to digital converter to a CPU. As understood, the CPU then calculates the density of the reflected light and stores and utilizes that density for comparison purposes.

This illustrative art, as well as other prior art, does not appear to provide a combination of a spectral-spatial vision system capable of sensing, identifying and analyzing either spectral information, spatial information or both. Moreover, the vision sensing industry does not appear to have a design for doing so. More particularly, there is believed to be no such combination in which a single sensor and single analytical processing unit may be used to analyze either spectral information, spatial information, and/or both.

### SUMMARY OF INVENTIONS

The present inventions are primarily directed to a low cost, combination spectral and spatial sensor and identifier that will enable separate and/or simultaneous identification and analysis of objects and substances by their color and/or dimensional characteristics. Such includes a unique combination of the capabilities of spectral sensor and identifier disclosed in U.S. Pat. No. 6,919,959 which issued on Jul. 19, 2005 with the capabilities of the spatial sensor and identifier disclosed in U.S. Pat. No. ______ which is to issue on application Ser. No. 10/655,711 filed Sep. 4, 2003. As noted earlier, both of these patents, their applications and their disclosures are incorporated by reference into this application as if they were fully set forth herein.

In the preferred embodiment, this combined spectral-spatial unit employs a single sensor, a lens system directing light through a diffraction grating to at least one area imager or area array of pixels. The diffraction grating deflects a plurality or sector of wavelengths of light onto each pixel to develop a voltage thereon, this voltage being representative of the quantity of light received by each pixel. The voltages of these pixels, when plotted or serially placed in an electronic memory then represent and define a definitive spectral or spatial distribution or fingerprint that defines the object, substance or its condition. Software programmed for a controller, preferably a Digital Signal Processor (DSP), reads the output of a column (or row) of pixels to obtain a sample spectral or color distribution of wavelengths (fingerprint) of the object for comparision, identification or analysis. Another algorithm programmed for the controller, then reads the output of a perpindicular row (or column) to obtain a sample spatial distribution of a particular wavelength (fingerprint), depending upon the row chosen, of the object for comparison. Each of the fingerprints are then compared with a “standard” spectral and/or spatial distribution (fingerprint) held in memory by a comparison algorithm that compares the sample fingerprint with the standard fingerprint. The result of the comparison may be to identify the sample as identical or as having a degree of similarity to the standard or, alternatively to repudiate the identity or similarity. The results of the comparison are made known through an output or a generation of a visible, audible or electrical signal.

By using an area imager array, and selecting the output of a series of pixels in one direction (a horizontal row for example) a spectral image of an object can be obtained while selecting output of a series of pixels in the perpendicular direction (a vertical column for example) results in a spatial image of the object. Consequently, according to the preferred embodiment of this invention, the components, including the lens, memory and the DSP need not be duplicated to obtain a spectral and a spatial image of an object in single unit having a single housing. In operation, controls and algorithms are provided to enable the user to select either a spatial or a spectral analysis of the object, or in instances in which one would like to be more certain of the analysis, appropriate controls and algorithms would have the unit run both a spectral and a spatial analysis. (In other alternative designs, the user may desire to duplicate one or more of the components). Those acquainted with the art will recognize that each spatial element can be represented by a single color element or by any set of the color elements available in the spectrum sensed by each column. For example, if the row, to which red light is directed by the diffraction element, is used for spatial evaluation, the red reflectivity of the surface will be analyzed for its spatial character. If a row to which blue light is directed by the diffraction element is used for spatial evaluation, the spatial fingerprint will consist of the voltages of the pixels having blue reflectivity and such will be analyzed for its spatial character.

Those acquainted with the art will also recognize that combinations of colors can be used to recognize particular events that are of interest. An example of such a method is to employ a filter such as red to infrared ratio. Such an algorithm would use the red spatial information from the red row and the infrared information from the infrared row, take the value of red from the first element in the row and divide it by the value from the first element of the infrared row and place it in memory. This process repeated for each element in the row produces an “image” of the red to infrared ratios in memory. The information contained in this memory can be used to extract information from the object or compare it to information stored in memory. Similarly, an algorithm which calculated the correlation coefficient can be used. Such an algorithm would produce an “image” of the correlation between the selected spectral elements of the sample and the standard.

Accordingly, the goals and objectives of this invention are to provide, among other things,

1. a method and apparatus for combining spectral and spatial sensing and identification and condition of objects in a preferably, a small low cost handheld unit although in may instances it may be mounted above conveyers, on robots, and other machines;

2. a very accurate multi-wavelength spectral and/or spatial identification and recognition method and apparatus;

3. a combined spectral and spatial sensor having a simple, low cost setup for identification and analysis of objects, substances, etc.;

4. a simple, lost cost, minimum maintenance apparatus and method for identifying, grading or selecting objects, substances, plant and animal tissue by light received from their surfaces using spectral and/or spatial reflections;

5. a low cost scanning and sensing device having a target or aiming system to identify the point, area and object whose spectral image and/or spatial image is being generated;

6. a combined, low cost sensor capable of sensing the spectral and/or spatial characteristics of an object or substance, and

7. a combined, low cost spectral and spatial sensor and method having one or more analytical microprocessors for identifying objects, substances, etc by their combined spatial and spectral attributes, or alternatively, by either the spectral or spatial attributes of said objects, substances, etc.

### DESCRIPTION OF THE DRAWINGS

The manner in the foregoing objectives and other desirable sensing capabilities are achieved by this invention is explained in the following specification and attached drawings in which:

FIG. 1 is a perspective view of a preferred embodiment of the intended physical elements of sensor and identification unit with portions broken away with a block diagram of the electronic components to be used for identification.

### DETAIL DESCRIPTION

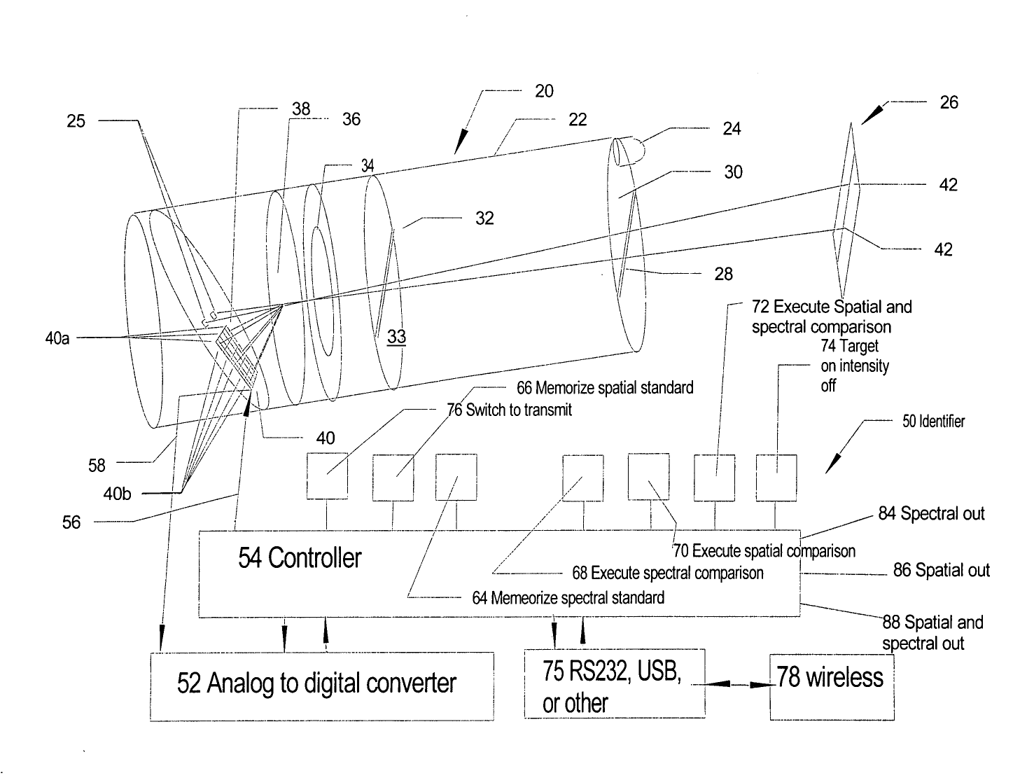

As depicted in FIG. 1, the preferred embodiment of these inventions comprises a comprises a sensor-identifier unit 20 contained in a tubular housing 22. This housing 22 carries, preferably, a high intensity lamp 24 for directing light on the object or substance 26 that is to be identified. Target lights or led's 25 carried by a mounting board 21 in the rear of the unit may be used to properly align the unit with the object 26 to be identified. Light reflected or otherwise received from this object 26 is directed through a horizontal slit 28 in a front plate 30 of the housing 22 to permit a horizontal band of light to pass to a second slit 32 formed in a rear plate 33 suitably fixed to the interior of the housing 22. The two slits, 28 and 32, direct the light through a lens 34 and through a diffraction grating 36 for diffracting said light in a plurality of groups or segments of light wavelengths upon pixels 38 of an image area array 40. The light is divided in numerous segments of light wave lengths to impinge upon numerous pixels. The pixels 38 are, preferrably, divided into columns 40a and rows 40b with each row or column containing from 1 to 100 or more pixels. Those skilled in the art will appreciate that the higher the number of pixels in the rows and columns will provide a digital voltage fingerprint of greater detail and a more fully defined spectral or spatial distribution of the surface of the object 26.

As shown, the light is diffracted upon a total of 5 pixels in vertical columns 40a of the area array 40. As is well known in the art, each pixel generates a voltage that corresponds to the quantity of light received from the object 26 with the result that the voltage on the pixels represents a spectral distribution or fingerprint of the light received from the object. Such fingerprints are usually very unique to the object or substance 26 in question and may be used to identify the object, substance and/or the condition of each. A single column 40a of the pixels of the area imager 40 define this fingerprint. Preferably, the single, middle column is used to define the spectral fingerprint. However, any of the columns may be selected, and the fingerprint of each can be compared to the fingerprints stored in memory to determine if any of them matches or is similar to the standard. This spectral fingerprint is more fully described in prior application Ser. No. 11/494,080 and the patents and applications above identified and incorporated by reference into this application.

In addition the use of a column of pixels to identify and define the spectral fingerprint of the object or substance, or its condition, the band of light is also transmitted through the plate slit 32, the lens 34 and the diffraction grating 36 to the horizontal rows of pixels 40b of the array 40. Light received by these horizontal rows 40b of pixels define the spatial fingerprint of the object, i.e., the profile and dimensions of the surface of the object 26 between the target light projections 42. Preferably, the center row of pixels is used to define the spatial fingerprint, i.e., the voltages of the pixels of the horizontal, center row of pixels 40b. Those acquainted with the art will recognize that each row contains spatial information with regard to a specific and unique wave length of light. If a black and white object is viewed, each row will contain similar information. If, however, the object is red and white, the red row will contain very little if any information in that the red and white regions of the object both reflect red light. However, the blue row would contain high quality information as the red and white object reflects no blue from the red regions and much blue from its white regions.

Additionally, those acquainted with the art will note that complex information is available for use. An example is that blood oxygen levels can be obtained from a ratio of the absorption of red and infrared light. Imaging a region containing blood of varying degree of oxygen would require the computation of the ratio of red to infrared light. Thus, the value of the sensor elements of the row containing red light can be divided by the value of the sensor elements of the row containing infrared light and stored in memory. This memory contains an “image” of the blood oxygen levels of the region. Locations of areas of high, or low, or desired levels of blood oxygen can thus be determined. If desired, additional information on the spatial fingerprint can be found in my prior application Ser. No. 10/655,711 now U.S. Pat. No. 7,362,423 which, as noted above, is incorporated into this application by reference as if fully set forth herein.

As described, the above sensing unit 20 is capable of obtaining both a spectral fingerprint of a point or line on the object and a spatial fingerprint along a line of the object 26 between the points 42-42 that represent the points at which the target lights 25 intersect on the object 26.

In accord with my preferred invention, these spectral and spatial fingerprints obtained by the sensor unit 20 may then be transferred from the sensor-imager 40 to a digital identifier 50 for comparison with standard fingerprints previously stored in memory that is associated with a controller 54. This identifier 50 may, preferably, also be enclosed in the housing 22 upon the mounting board 21 of the sensor, or alternatively, it may be carried by a separate circuit board placed in a second housing.

The identifier 50 may includes an analog to digital converter 52 which converts the analog pixel voltages to digital information to facilitate use by the controller 54 of spectral distributions. The identifier 50 also includes a controller 54 which may take the form of a micro-controller, a micro processor or, preferably, a digital signal processor (DSP) or other computing device having an arithmatic logic element and which provides sufficient speed for the sensing application intended by the user.

The controller 54 initiates reading the voltages developed on the pixels 38 through a lead 56 and those voltages are downloaded to the A-D converter 52 through a lead 58. The digital fingerprint is then transferred to an appropriate memory (not shown) associated with the controller 54.

This controller 54 includes (or is connected to) a substantial memory in which at least one or more addresses contain “standard” spatial and/or spectral images (fingerprints) to be used for comparison purposes. The controller 54 is also provided with (or connected to) a second memory section or element for retrieving and holding spatial and/or spectral images (fingerprints) of objects to be received from the columns 40a and the rows 40b of the area imager and which are to be compared with the “standard” fingerprints to ascertain their identity, condition, dimensions, color, etc. Finally, the controller 54 also contains a third memory or section containing a control algorithm identifies the sample fingerprints to be compared with the “standard” fingerprints together with a comparison algorithm such as a regression analysis that determines the similarity between the standard fingerprint and the fingerprints of the objects to be investigated.

To use this system and its methods, the user must first install “standard” or “reference” spatial or spectral distributions (fingerprints) of the objects or fluids that are to be used for comparison and identification. Such can be done by merely downloading such fingerprints into the memory associated with the controller 54 through conventional programs. However, to facilitate many applications, the user may prefer to select an image that is to be the standard and, using a pushbutton or switch, place the standard into the memory of the controller 54. This method is, in essence, a quick “pushbutton setup.” For example, if the user wants to insure that the color of leather to be used as a seat cover for an automobile matches the color of the leather of the door, the user would merely aim the sensor 20 at the leather door, and activate switch or (push button) 64. Upon activation of the switch 64, the unit would be wired or programed to cause the sensor to take a spectral distribution of the leather of the door and place it in memory as a “standard.”

Thereafter, the controller 54, which may be loaded with and which is programmed to run a control algorithm and a comparison algorithm, (preferably an algorithm for running a regression analysis) is activated by a switch or pushbutton 68. Upon activation, the controller 54 takes a spectral distribution of an object to be identified, converts it to digital form through the A-D converter 52, and compares that spectral distribution with the leather door distribution that has been stored as a standard and previously placed in memory. The user is then informed of the results of the comparison by an electrical output at 84 which may be converted to a sound or light or other message. Alternatively, those skilled in the art will appreciated that the spectral distributions could be transmitted to a scope or computer for visual confirmation by the user. Switch 76 is provided for this purpose. If desired, discriminating switches could be added as reflected by my prior applications to increase or decrease the coefficient correlation of the regression analysis. Such will permit the unit to determine the certainty of the comparison between the standard and the sample or, alternatively, to identify similarity by choosing a lower coefficient of correlation.

In a similar fashion, a user of the device can elect to use the sensor for spatial determinations such as those shown in patent application, Ser. No. 10/655,711, now U.S. Pat. No. ______.

To accomplish this determination, the user would utilize a button such as 66 to activate the controller 54 which in turn would be wired or programmed to cause the sensor 20 to take a spatial configuration of a first object 26 as a standard, such as a previously inspected machined part that conforms to the desired specifications and to place it in a “spatial memory” or address. Thereafter, the user might activate the spatial comparison routine and algorithm by pushing button or activating switch 70. Such would activate a comparison routine directing the sensor 20 to take spatial distributions of subsequently manufactured machined parts and the digital identifier 50 would immediately compare it with the standard through a comparison algorithm such as a regression analysis. The results of the comparison would be sent to the output 86 which could be a desired signal such as a voltage, a noise or light or other media. If, for example, the subsequent machined part failed to conform to spatial distribution of the standard, a red light might be activated, or an ejector would push the non-conforming part off of a conveyor.

In another illustration of the use of this invention, a user might want to insure that fruit, such as picked cherries conformed to a specific size and a specific color for a specific grocery. To accomplish this, the user would aim the sensor 20 at a specific cherry that is acceptable, activate switches 64 (to memorize the color standard) and 66 (to activate the size standard). Thereafter, the sensor 20 could be mounted above a conveyor moving picked cherries into an packaging station (not shown). Pushbutton or switch 72 would be activated to make the comparisons with the spectral and spatial fingerprints of sequential cherries moving on the conveyer, and the output of the identifier would be used to activate an ejector that removed non-conforming cherries from the conveyor and the packaging area.

As noted above, the spectral identification of the object was, in actuality, an identification of the color of a single point on the object 26. However, light from along a line connecting the target light images 42 on opposite sides of the object 26 passes through the slits 28 and 32 and such is diffracted upon each column 40a of the area imager. Thus, each column 40a will contain a spectral fingerprint of a different point along the line between the two target lights that are imposed on the object. For example, if the area imager 40 has 50 columns of pixels 38, one could obtain 50 spectral fingerprints of 50 short line segments or points across the object 26. Accordingly, if one wanted to inspect a label on a bottle (not shown), one could take 50 spectral fingerprints of the bottle, place them in memory as a standard and compare each of 50 spectral fingerprints on additional bottles with the 50 fingerprints stored as a standard. Those skilled in the art might well chose to utilize a regression analysis for such a comparison with an algorithm run by the controller or DSP 54.

Those acquainted with the art will also recognize that slit apertures 32 and 23 could be replace by spatial light modulators such as liquid crystals to provide for a movable or adjustable aperture that could be used to select different lines of view across the object. (Moving the aperture 23 would select a different line (target 42).

In poor light and under the necessary circumstances, the intensity lamp 24 as well as the target lights 25 could be activated to provide additional light or to insure that the sensor 20 is properly aligned with the object 26. However, it is preferred that the target lamps 25 be turned off when the intensity lamp 24 is turned on and that the target lamps be turned on when the intensity lamp is turned off.

Those skilled in the art will appreciate that various alternatives may be used to design a control circuit (not show) by which the pushbutton switches (64-74) could be used to initiate operation of the sensor-identifier 20-50. Those skilled in the art will also appreciate that the definitions of the buttons can be changed and the algorithms run changed by use of the computer interface 75. In addition, those skilled in the art will also appreciate that various control algorithms and comparison algorithms could be used to obtain and store the spatial and spectral images and run the identification and condition comparisons necessary to compare the standard spectral and/or spatial fingerprint with the object or subject in question. Indeed, such alternatives are, in part, set forth in the prior patents that are incorporated herein by reference.

In addition, those skilled in the art will appreciate that RGB filters may be used as a substitute for the diffraction grating 36 although its limited fingerprints would result in substantially less accuracy and reliability. Also, as shown in the prior incorporated patents, persons skilled in the art will appreciate that the sensor 20 alone, would take spatial and spectral fingerprints and such could be immediately transmitted to a remote station via a wired or wireless communication system (75 and/or 78).

Those skilled in the art will also appreciate that the controller 54 could be selected from various alternatives such as micro-controllers and digital signal processors. Each alternatively could be incorporated into a specifically engineered circuit board and programmed with the various comparison algorithms including the preferred regression analysis algorithm or a regression algorithm in which the coefficient of regression could be changed. Too, various area arrays could be used, as well linear arrays in which one would be for spectral and the other for spatial. Indeed, one might use a separate area or linear array for spectral analysis and for spatial analysis. A very beneficial concept the preferred embodiment of this invention is the push-button setup in which an actual sample is used set the “standard fingerprint.” Such avoids the prior building of a separate electronic library from which the standard of comparison is to be taken. Various programs might be run with the controller 54 so as to compare a single column of the pixels with a different column of pixels, or, alternatively, the sum of the voltages of one or more columns might be used for the comparison. Those skilled in the art will appreciate these and various other alternative choices that designers may take in adopting and using the preferred and alternative inventions.

I claim:

1. A combination vision system for selectively sensing spectral and/or spatial information from an object or substance and for analyzing such information to determine the identity, condition or other information about said object or substance, said system comprising:
a) a sensing apparatus for receiving light from said object or substance and for directing at said light upon a imaging system to obtain a first linear digital spectral image of at least a portion of said object or substance and a second linear digital spatial image of at least a portion of said object or substance; and
b) a digital processing unit for receiving said images and for determining the identity, condition or other information of said object or substance.

2. A combination as recited in claim 1 in which said sensing apparatus comprises
a) a lens system for directing said light through a diffraction device to divide said light into segments of wavelengths; and
b) said imaging system comprises at least one area array that is positioned so as to receive said diffracted light; and
c) said digital processing unit receives said spectral image from a first group of pixels of said area array and said spatial image from a group of pixels perpindicular to said first group of pixels.

3. A combination as recited in claim 1 in which said digital processing unit includes a Digital Signal Processor having an algorithm for determining said identity, condition or other information from said object or substance.

4. A combination as recited in claim 1 in which a memory is associated with said digital processing unit and said memory contains at least one digital spectral image or digital spatial image for comparison with the spectral or spatial image of said object or substance to determine its identity, condition or other information.

5. A combination as recited in claim 4 in which said at least one digital or spectral comparison image is created by aiming said combination at an object or substance and activating said combination to place said object or substance in said memory as a standard of comparison.

7. A sensing and identification device with a simple setup for identifying an object or substance, said device comprising:
a) a sensor having an imager for receiving light from an object or substance and for creating a unique digital fingerprint of said object or substance;
b) a digital identifier having a first associated memory for receiving a standard digital fingerprint of said object and a second associated memory for receiving a fingerprints of subsequent objects or substances to be identified and an associated algorithm for comparing said said fingerprints of said subsequent objects or substances with said standard digital fingerprint; and
c) a switch to initiate generation of said standard digital fingerprint.
